(19) United States
(12) Patent Application Publication
(10) Pub. No.: US 2017/0008590 A1
(43) Pub. Date: Jan. 12, 2017

(54) SELF-BALANCING UNICYCLE DEVICE

(71) Applicant: Timur Artemev, Haslemere Surrey (GB)

(72) Inventor: Timur Artemev, Haslemere Surrey (GB)

(21) Appl. No.: 15/187,078

(22) Filed: Jun. 20, 2016

(30) Foreign Application Priority Data
Jun. 18, 2015 (GB) 1510763.4

(51) Int. Cl. B62K 3/00; B62J 25/00; B62K 1/00

(52) U.S. Cl. CPC B62K 3/007; B62K 1/00; B62J 25/00

(57) ABSTRACT

A self-balancing transportation device is disclosed. The device comprises: a chassis; a drive arrangement adapted to move the transportation device; a balance control system adapted to maintain fore-aft balance of the transportation device; at least one support platform for supporting a load for transportation; and a coupling arrangement configured to couple the at least one support platform to the chassis. The coupling arrangement is adapted to allow the at least one support platform to move relative to the chassis in response to horizontal acceleration or deceleration of the transportation device.

### FIELD OF INVENTION

The present invention relates to powered transportation devices and more particularly to powered transportation devices with self-balancing functionality.

### BACKGROUND TO THE INVENTION

Powered self-balancing vehicles for transporting loads, such as packages or individuals, are known. Such vehicles include two-wheeled vehicles and single-wheeled vehicles (i.e. unicycles).

In a powered self-balancing unicycle, an electronic or mechanical system that controls the wheel in the appropriate direction is typically used to achieve fore-and-aft balance. This type of automatic fore-and-aft balance technology is well known and described, for example, in U.S. Pat. No. 6,302,230. A sensor and electronic equipment are typically provided. Information detected by the sensor and the electronics is relayed to a motor. The motor drives the wheel in the appropriate direction and at sufficient speed to maintain fore-and-aft balance.

The market for self-balancing unicycles of this type is strongly dependent on the weight of the product, which also influences the cost of manufacture of the device. There is therefore always a need to reduce production costs where possible.

One aspect is the number of different components that need to be manufactured to make the overall design.

### SUMMARY OF THE INVENTION

According to a first aspect of the invention, there is provided a self-balancing transportation device comprising: a chassis; a drive arrangement adapted to move the transportation device; a balance control system adapted to maintain fore-aft balance of the transportation device; at least one support platform for supporting a load for transportation; and a coupling arrangement configured to couple the support platform to the chassis, the coupling arrangement being adapted to allow the support platform to move relative to the chassis in response to horizontal acceleration or deceleration of the transportation device.

There is proposed a self-balancing wheeled transportation device comprising a coupling arrangement that allows the support platform to move relative to the chassis or stationary hub of the device. Such movement may be caused by horizontal acceleration or deceleration of the transportation device and may include a vertical component. For example, the coupling arrangement may be adapted to allow the support platform to swing relative to the chassis or stationary hub of the device when the device undergoes sudden or rapid horizontal acceleration or deceleration. Embodiments may therefore provide an arrangement which is adapted to transfer at least part of the horizontal momentum (e.g. in the forward or backward direction) of the device into movement of the support platform when the device hits a small bump or obstacle for example. For example, at least some of the forward running momentum of the device can be translated into vertical movement of the support platform which can act toward lifting the device (reduce the effective weight of the device) and thus reduce an amount of torque/power required to overcome the bump or obstacle. Embodiments may therefore reduce or alleviate power or torque requirements on the drive arrangement. Such reduction of required torque, for example, may enable a smaller, lighter and/or cheaper motor to be employed, thus reducing the cost and/or weight of the device.

The load for transportation may comprise a package. Embodiments may therefore provide a powered self-balancing transportation device for transporting package or items of stock in an automated manner.

Alternatively, the load for transportation may comprise a person. Embodiments may therefore provide a powered self-balancing transportation device for transporting a person or individual.

Embodiments may also help improve device safety by reducing (e.g. damping) the effect of hitting a sudden bump or obstacle, etc. For example, a sudden deceleration of the device may not be mirrored by the support platform(s). Instead, relative movement of the support platform(s) to the chassis of the device may mean that the load for transportation experiences less or more gradual deceleration.

The coupling arrangement may be adapted to restrict or prevent the support platform from moving relative to the chassis if the horizontal acceleration or deceleration of the transportation device does not exceed a predetermined threshold value. In this way, the coupling arrangement may be adapted to prevent the support platform from being freely suspended so that it does not swing freely. Instead, embodiments may be adapted such that only acceleration or deceleration of the wheel(s) or transportation device exceeding a certain threshold amount results in movement of the support platform relative to the chassis. This may help to improve the stability, safety and/or usability of the device.

Embodiments employ the realisation that traveling momentum of a load may be used to effectively pull the device forwards and upwards by allowing the support platform to move (e.g. swing) relative to the chassis or hub of the device. Some embodiments propose to use the support platform(s) to convert or translate linear momentum of the device/user into a vertical lifting force by enabling the support platform(s) to move in a direction having a vertical component when the wheel suddenly decelerates (due to hitting a bump, small step, obstacle, etc.). Such generated upward lifting force may help to lift the wheel over the bump or obstacle, so that the amount of toque required by the drive arrangement may be reduced when compared to conventional devices hitting the same bump or obstacle.

In embodiments, the coupling arrangement may be adapted to maintain the support platform(s) in a constant orientation when it moves relative to the chassis. Embodiments may therefore maintain an upper (user-supporting) surface of the support platform(s) in a substantially horizontal configuration so that the user-supporting-surface of the support platform does not tilt when it moves. This may help to prevent the user from losing their balance, and thus improve the safety and/or usability of the device.

The coupling arrangement may comprise a mechanical linkage having two link arms, wherein each link arm has two ends and is pivotally coupled to the chassis at one end and is pivotally coupled to the support platform at the other end. Further, the two link arms may be of substantially equal length such that that the link arms together with the chassis and the support platform form a parallelogram four bar linkage. Embodiments may therefore employ a simple and/or cheap arrangement for enabling the support platform(s) to move in a swing-like manner.

In an embodiment, the coupling arrangement may comprise a track and follower for guiding the allowed movement of the support platform along a predetermined path. Also, the predetermined path may extend in an upward direction. In other words, a track and follower arrangement may be employed so as to restrict the allowed movement of the support platform to a predetermined path that extends (at least in part) in a vertical or upward direction (i.e. in a direction that is not horizontal). Such a path may be non-linear (i.e. curved) for example. Horizontal momentum of the device/user may thus be translated or converted into vertical momentum of the support platform(s).

Embodiments may further comprise a biasing arrangement adapted to apply a lifting force to the at least one support platform(s). Embodiments may further comprising a bias actuation arrangement that is adapt to apply or remove the lifting force to the at least one foot platform under the control of an activation signal. The activation signal is based on one or more operating characteristics of the device

The self-balancing transportation device may be a self-balancing unicycle device having a single primary wheel adapted to be driven by said motor. Embodiments may therefore provide a powered self-balancing unicycle device that employs a smaller, lighter and/or cheaper motor than conventional devices.

Further, in an embodiment, the single primary wheel may be hubless and wherein the device may further comprise a drive wheel adapted to be rotated by a motor and to contact the inner rim of the single. In another embodiment, the wheel may have a hub (i.e. not be a hubless wheel).

In another embodiment, the self-balancing transportation device may comprise a pair of wheels, and the at least one support platform may be positioned between the pair of wheels. For example, embodiments may include powered self-balancing two-wheeled transportation devices having a support platform situated between the two wheels (so that the user is intended to stand between the two-wheels for example). In such embodiments, there may be provided a single support platform for supporting the user (between the wheels), and the support platform may be suspended from a chassis of the device by a linkage such that the linkage allows the support platform to move relative to the chassis.

Embodiments may therefore be adapted to cater for various configurations of support platforms, such as: single support platforms that extend through the unicycle device so as to protrude from either side; or separate support platforms (provided for each foot of a user) situated on opposite sides of the unicycle device.

In an embodiment, there may be provided an actuator arrangement coupled to the at least one support platform and adapted to move the at least one support platform between a stowed configuration and an active configuration. Also, the actuator arrangement may comprise a telescoping actuator adapted to move between an extended and retracted configuration so as to move the support platform between the stowed configuration and active configuration.

Telescoping actuators are specialized linear actuators that may be used where space restrictions exist, mainly because their range of motion can be many times greater than the retracted (or unextended) length of the actuating member. A form of telescoping linear actuator is made of concentric tubes of approximately equal length that extend and retract like sleeves, one inside the other, such as a telescopic cylinder. Telescopic cylinders are a special design of hydraulic, electric or mechanical cylinders which provide a long output travel from a compact retracted length. Typically, the collapsed length of a telescopic cylinder may be 20 to 40% of the fully extended length depending on the number of stages. Some telescoping units may be manufactured with retracted lengths of under 15% of overall extended unit length. Thus, employment of a telescoping actuator may help to reduce the size (e.g. thickness, length or vertical profile) of the actuator arrangement when the foot support is in either configuration, thereby allowing the unicycle device to have a slim body. In other words, embodiments may employ a telescoping actuator which helps to reduce the size and/or width of the unicycle device. A proposed actuator arrangement may thus help to ensure that sufficient leverage can be generated to move the support platform(s), while maintaining a slim-line design to ensure the unicycle can meet predetermined size, weight, height or volume requirements. The telescoping actuator may, for example, further comprise: one or more hydraulic, electric or mechanical actuators adapted to move the telescoping actuator between the extended and retracted configuration. Embodiments may therefore employ a simple and cheap arrangement that can be driven so as to move the support platform between predefined configurations.

For the avoidance of doubt, reference to a single, primary wheel should be taken to mean the generally circular unit that is positioned between the legs of a user and adapted to rotate about an axis to propel the unicycle in a direction during use. The single wheel may therefore be formed from one or more tyres and/or hubs that are coupled together (via a differential, for example). For example, an embodiment may comprise a single hubless wheel having a single hubless rim with a plurality of separate tyres fitted thereon. Alternatively, an embodiment may comprise a single hubless wheel formed from a plurality of hubless rims (each having a respective tyre fitted thereon), wherein the plurality of hubless rims are coupled together via a differential bearing arrangement.

Embodiments may provide a self-balancing powered transportation device that can alter the position of the support platform(s) relative to the wheel or body portion of the device, and such alteration may be caused or driven momentum of a user supported on the support platform(s). Momentum of a user may thus be translated (by movement of the support platform(s) to a different direction which helps to lift the device over a bump or obstacle for example.

### BRIEF DESCRIPTION OF THE DRAWINGS

An example of the invention will now be described with reference to the accompanying diagrams, in which:

FIG. 1 is an isometric view of an embodiment of a powered unicycle device in a closed configuration;

FIG. 2 is an exploded diagram of components internal to the casing of FIG. 1,

FIGS. 3A & 3B are side and front elevations, respectively, of the embodiment of FIG. 1, wherein the casing is moving between a closed and open configuration;

FIGS. 4A & 4B are side and front elevations, respectively, of the embodiment of FIG. 1, wherein the casing is in an open configuration and the foot platforms are in a stowed configuration;

FIG. 5 is an isometric view of the embodiment of FIG. 1, wherein the casing is in an open configuration and the foot platforms are in a stowed configuration;

FIGS. 6A & 6B are side and front elevations, respectively, of the embodiment of FIG. 1, wherein the casing is in an open configuration and the foot platforms are in an active configuration;

FIG. 7 is an isometric view of the embodiment of FIG. 1, wherein the casing is in an open configuration and the foot platforms are in an active configuration;

FIG. 8 is a side view of the embodiment of FIG. 1, wherein the casing is in an open configuration and the foot platforms are in an active configuration, and wherein the foot platforms are depicted as swinging forward as a result of the unicycle hitting an obstacle when travelling a forward direction;

FIG. 9 is a schematic side view of an embodiment of a powered unicycle device, wherein the unicycle device is depicted at the moment of hitting an obstacle when travelling a forward direction;

FIG. 10 is a schematic side view of another embodiment of a powered unicycle device, wherein the unicycle device is depicted at the moment of hitting an obstacle when travelling a forward direction;

FIG. 11 depicts a modification to the embodiment of FIG. 10;

FIG. 12 depicts another modification to the embodiment of FIG. 10; and

FIG. 13 depicts a modification version of the embodiment of FIG. 12.

### DETAILED DESCRIPTION

Proposed is a powered self-balancing transportation device having a mechanical linkage configured to suspend the foot platform(s) from the chassis device such that the foot platform(s) can move relative to the chassis in response to horizontal acceleration or deceleration of the device. Such movement may comprise a swinging-like movement such that the foot platform(s) may transfer linear momentum (e.g. in the forward or backward direction) of the device into vertical momentum, for example when the device experience sudden deceleration due to hitting a bump or obstacle. Thus, forward running momentum of the device can be translated into vertical movement of the foot platform which can act towards lifting the device and thus reduce the effective weight of the device. Proposed embodiments may therefore reduce or alleviate power or torque requirements on the drive arrangement when attempting to overcome bumps or obstacles.

The term vertical, as used herein, means substantially orthogonal to the generally horizontal ground surface upon which a unicycle may be ridden. The term lateral, as used herein, means substantially parallel to the generally horizontal ground surface. Also, terms describing positioning or location (such as above, below, top, bottom, etc.) are to be construed in conjunction with the orientation of the structures illustrated in the diagrams.

The diagrams are purely schematic and it should therefore be understood that the dimensions of features are not drawn to scale. Accordingly, the illustrated thickness of any of the components or features should not be taken as limiting. For example, a first component drawn as being thicker than a second component may, in practice, be thinner than the second component.

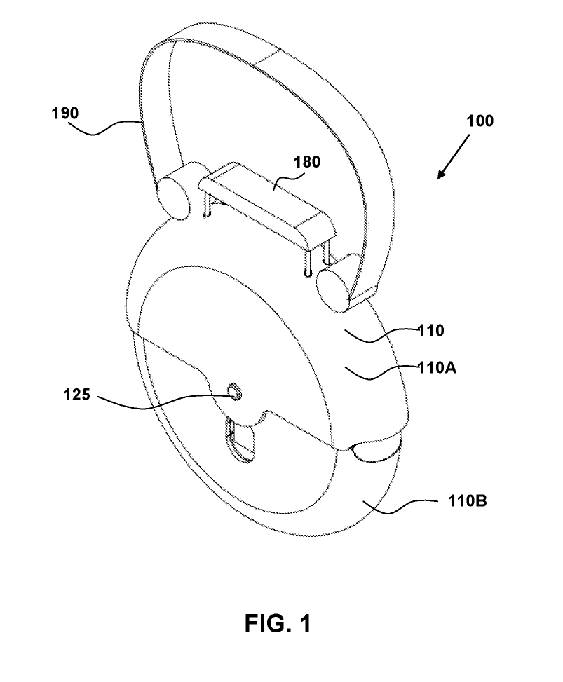

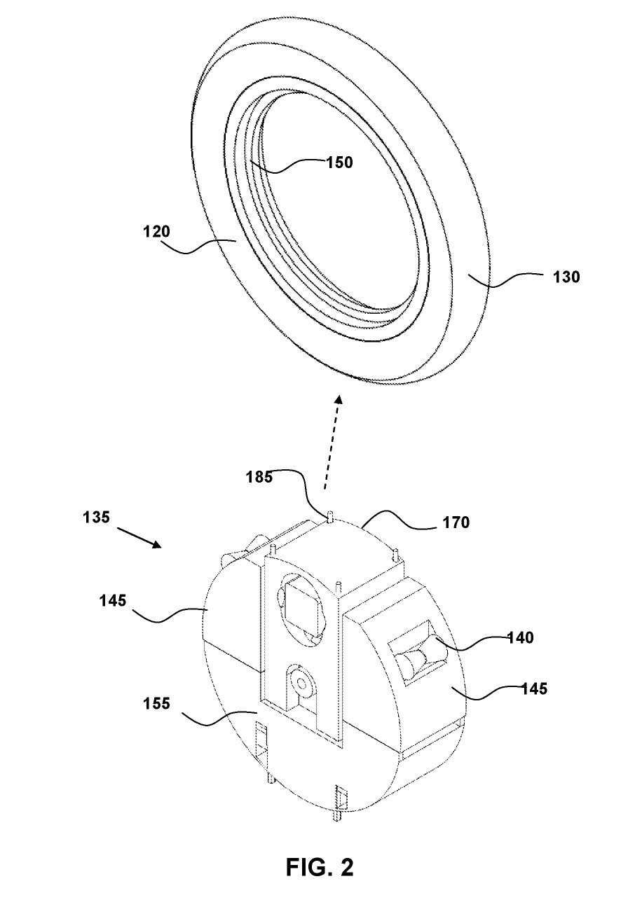

FIGS. 1-8 show one embodiment of a powered unicycle device 100. FIG. 1 shows the powered unicycle device 100 with a casing 110 in a closed configuration so that it encases a single wheel 120. Here, the casing 110 is formed from a first, upper portion 110A that covers the top (uppermost) half of the wheel 120, and a second, lower portion 1108 that covers the bottom (lowermost) half of the wheel 120. FIG. 2 illustrates an exploded view of components internal to the casing 110, namely a wheel 120 and drive arrangement 135.

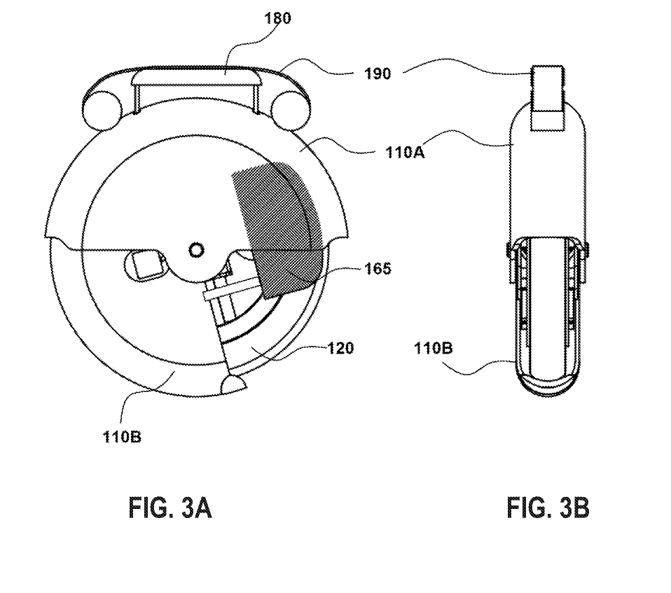

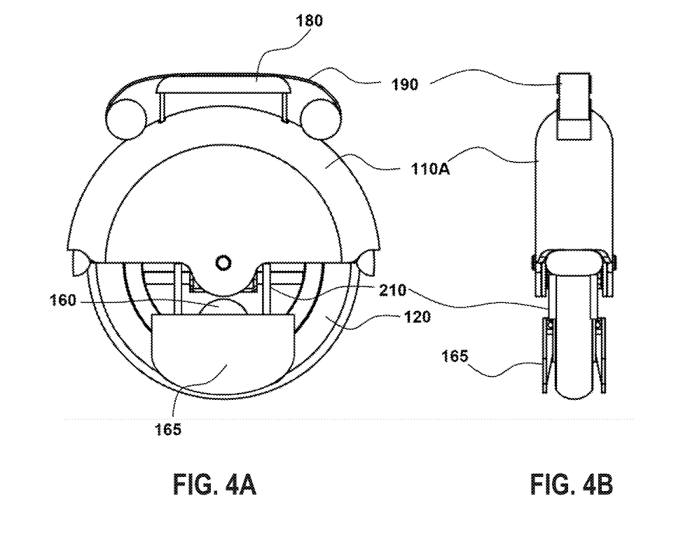

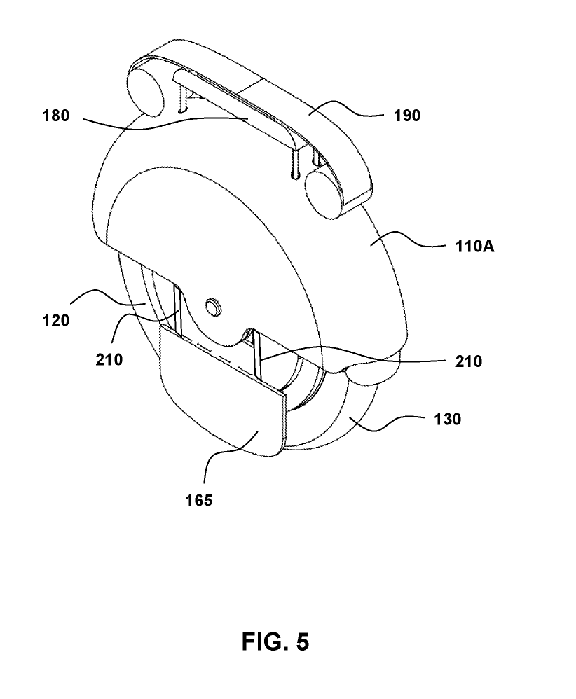

Referring back to FIG. 1, the wheel 120 spins about a central axis 125. The first, upper portion 110A of the casing is retained in a fixed position relative to the central axis 125, whereas the second, lower portion 1108 of the casing is adapted to rotate about the central axis 125. Rotation of the second lower portion 1108 about the central axis 125 moves the casing between closed and open configurations (as illustrated by FIGS. 3-4). In the closed configuration (shown in FIG. 1), the casing 110 encloses the wheel 120 so that the outer rim 130 of the wheel 120 is not exposed. In the open configuration (shown in FIG. 5), the outer rim 130 of the wheel 120 is exposed so that it can contact a ground surface.

Referring now to FIG. 2, rotation of the single wheel 120 is driven by a drive arrangement 135 according to an embodiment. The drive arrangement 135 includes guide wheels 140 attached to an outwardly facing side of respective batteries 145. In this embodiment, there are two pairs of angled guide wheels 140, wherein the two guide wheels in each pair share are tapered or conical such that they have a sloped surface which is not perpendicular to the radial plane of the single wheel 120. Put another way, the contact surface of each guide wheel is inclined with respect to the radial plane of the single wheel 120. The guide wheels 140 of each pair are also positioned spaced apart to provide a gap between the two guide wheels of a pair.

A rib 150 is provided around the inner rim of the wheel 120 and fits into the gap between the two guide wheels 140 in each pair. The guide wheels 140 are therefore adapted to contact with the inner rim of wheel 120 where they spin along with wheel 120 and hold wheel 120 in place by way of the rib 150. Of course, it will be appreciated that other arrangements, including those with only one guide wheel per battery 145, are possible.

The batteries 145 are mounted on a motor 155 which drives a pair of drive wheels 160 positioned at the lowermost point along the inner rim of the wheel 120. The batteries 145 supply power to motor 155 and, this embodiment, there are two batteries in order to create a balanced distribution of volume and weight. However, it is not necessary to employ two batteries 145. Also, alternative energy storage arrangements may be used, such as a flywheel, capacitors, and other known power storage devices, for example.

The drive wheel 160 is adapted to contact the inner rim of the wheel 120. The drive wheel 160 for example comprises a wide roller with a groove in the center into which the rib 150 fits. By way of contact with the inner rim of the wheel 120, the drive wheel 160 transmits torque from the motor 155 to the wheel 120. It will be understood that this drive system operates by friction and it may be preferable to avoid slippage between the drive wheel 160 and the inner rim of wheel 120. Positioning the drive wheel 160 at the lowermost point enables the weight of a user to provide a force which presses the drive wheel 160 against the inner rim of the wheel 120, thereby helping to reduce or avoid slippage.

Referring to FIGS. 5-7, two foot platforms 165 are coupled to the second, lower portion 1108 of the casing 110, with one on each side of wheel 120. More specifically, the foot platforms 165 are coupled to the second, lower portion 1108 of the casing 110 via a mechanical linkage 210 (which will be described in more detail below). The mechanical linkage 210 is adapted to enable the foot platforms 165 to move relative to the casing 110 in a swinging motion when the device undergoes a sudden or rapid acceleration or deceleration.

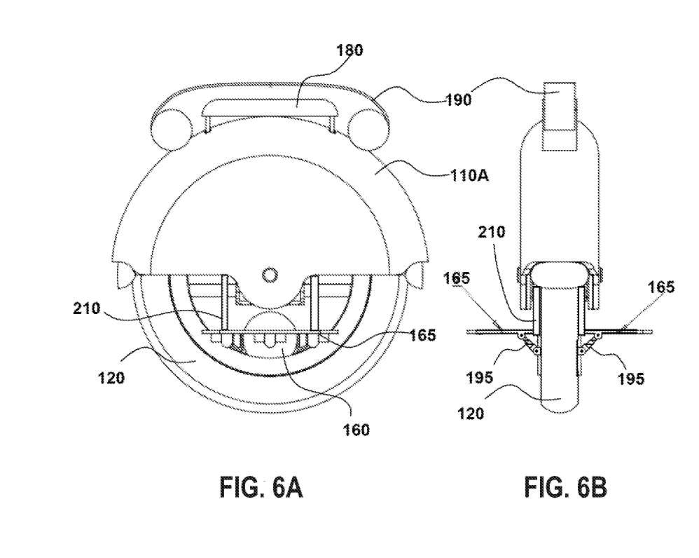

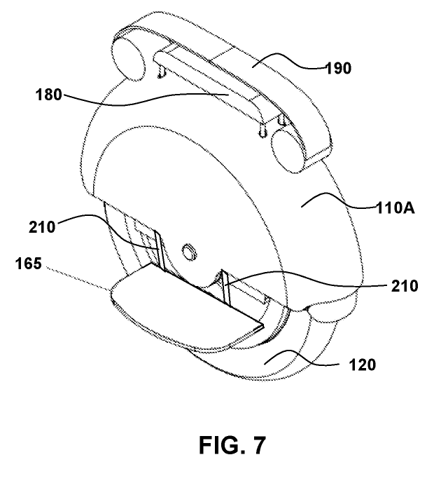

In the open configuration, the foot platforms 165 are movable between a stowed configuration, wherein the foot platforms are substantially parallel with the plane of the wheel (as shown in FIG. 5), and an active configuration, wherein the foot platforms are substantially perpendicular to the plane of the wheel (as shown in FIGS. 6-7) so as to support a user's weight. Thus, in this embodiment, the foot platforms 165 are movable between: (i) a stowed configuration wherein they are flat against the side of the wheel and can be rotated (with the second, lower portion 1108 of the casing) about the central axis 125 so as to be positioned inside (and covered by) the first, upper portion 110A of the casing; and (ii) an active configuration, wherein they project outwardly from the side of the wheel to provide a support surface for the feet of a user (as shown in FIG. 7). Accordingly, the foot platforms 165 are upwardly foldable into a stowed configuration that narrows the profile of the unicycle 100 to aid in storage and carrying. In use, the foot platforms are moved to the active configuration, and the user stands with one foot on each platform 165.

The drive arrangement 135 includes a gyroscope or accelerometer system 170 which it senses forward and backward tilt of the device in relation to the ground surface and regulates the motor 155 accordingly to keep the device upright. This enables the unicycle to self-regulate its balance in the fore-and-aft plane.

When not in use, the foot platforms 165 are moved to the stowed configuration and then rotated (with the second, lower portion 1108 of the casing) about the central axis 125 so as to move the casing to the closed configuration. Thus, in the closed configuration, the foot platforms 165 are stored inside the casing (covered by the first, upper portion 110A of the casing).

The example shown also comprises a lifting handle 180 coupled to the drive arrangement 135 via a plurality of rods 185. The lifting handle 180 is positioned at the top of the casing 110, above the wheel 120, and may be used to hold the unicycle 100 above the ground, for example to enable a user to lift, carry, convey or place the unicycle 100.

A retractable carrying strap 190 is also provided and attached to the top of the casing 100. The carrying strap 190 may be used to carry the unicycle 100, for example over the shoulder of user. A hook may be provided on the bottom of the case to create rucksack-like belts from the carrying strap 190.

The embodiment of FIGS. 1-7 further comprises an actuator arrangement (only partly visible in FIG. 6) coupled to the foot platforms 165 and adapted to move the foot platforms between the stowed configuration and active configuration. The actuator arrangement comprises first and second telescoping actuators 195 adapted to move between an extended and retracted configuration so as to move the foot platforms 165 between the stowed position and active position. In FIG. 6, the telescoping actuators 195 are shown in its extended configuration.

The actuator arrangement also comprise a connecting element attached to each foot platform 165 and pivotally coupled to the respective telescoping actuator 195 such that the connecting element moves (e.g. rotates) relative to telescoping actuator 195 as the foot platform is moved between the stowed position and active position.

Here, the telescoping actuators 195 move between an extended and retracted configuration so as to pivotally move the foot platforms 165 between the stowed configuration and active configuration. Pivotal connection to a connection element 197 results in the coupling position between a telescoping actuators 195 and associated foot platform 165 remaining fixed as the telescoping actuators 195 expands/retracts. To affect such movement of the telescoping actuators 195, the actuator arrangement further comprises an electric actuator, such as a motor, which is adapted to drive movement of the telescoping actuators 195 when activated. Of course, it will be understood that the actuator arrangement may employ other types of actuators to move the telescoping actuators 195 between an extended and retracted configuration, such as one or more appropriately arranged hydraulic, electric or mechanical actuators.

More specifically, the telescoping actuators 195 each comprise a telescopic cylinder formed from a plurality of nesting, telescoping sections that are adapted to extend and retract like sleeves, one inside another, so as to move between the extended and retracted configuration.

Although the above embodiment has been described above employing a telescoping actuators which are formed from a plurality of nesting, telescoping sections that are adapted to extend and retract like sleeves, it will be understood that other embodiments may employ other types of telescoping actuators. For example, other embodiments may employ telescoping actuators which use actuating members that act as rigid linear shafts when extended, but break that line by folding, separating into pieces and/or uncoiling when retracted. Examples of such an alternative telescoping actuator include: a helical band actuator; a rigid belt actuator; a rigid chain actuator; and a segmented spindle.

As detailed above, the embodiment of FIGS. 1-8 also comprises a linkage 210 configured to couple the foot platforms 165 to the casing 110. For each foot platform 165, the linkage 210 comprises two substantially parallel link arms 210. Each link arm 210 has two ends, wherein one end is pivotally coupled to the casing 110 and the other end is pivotally coupled to the foot platform 165. In this way, each link arm 210 can pivot with respect to the casing 110, and each link arm can also pivot with respect to its associated foot platform 165. In particular, the two link arms 210 are of substantially equal length such that that the link arms 210 together with the connection to the casing and the foot platform form a parallelogram four bar linkage.

It will be understood that this linkage arrangement can help to maintain the foot platform in a constant substantially horizontal orientation when it swings relative to the casing 110.

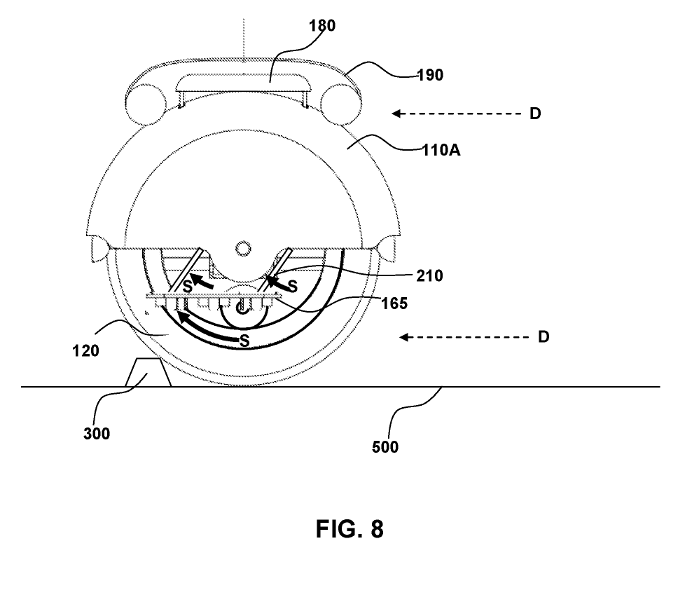

Referring now to FIG. 8, there is depicted an instance of the embodiment of FIGS. 1-7 hitting an obstacle 300 when travelling a forward direction (as indicated by the arrows labeled “D”).

As the wheel 120 hits the obstacle 300 it undergoes a sudden deceleration. However, the forward momentum of the supported user (not shown) and the foot platform 165 causes linkage 210 and the foot platforms 165 to undergo a swinging movement relative to the casing 110, as depicted by the arrows labeled “S”. This swinging movement is in a generally circular (or arc-shaped) direction due to the fixed length of the link arms 210. Thus, linear momentum of the unicycle device in the forward direction “D” is transferred into a swinging movement “S” of the foot platforms 165 when the device hits the obstacle 300. Thus, at least part of the forward running momentum of the unicycle device is translated into swinging movement that has a vertical component. The vertical component of the swinging movement may act towards lifting the device and thus reduce an amount of torque/power required to overcome the bump or obstacle. In other words, the vertical component of the swinging movement “S” of the foot platforms 165 may reduce the effective weight of the unicycle device, thus reducing or alleviating the power or torque required from the drive arrangement that would otherwise be required to overcome the obstacle.

Furthermore, because the upper (user-supporting) surface of the foot platforms 165 is maintained in a substantially horizontal configuration when it swings, the user-supporting-surface of the foot platform does not tilt relative to the ground/supporting surface 500, for example. This may help to prevent the user from losing their balance, and thus improve the safety and/or usability of the device.

The design described above has a static wheel hub, and thus the wheel may be referred to as “hubless” (since it does not comprise a hub with spokes for example). Put another way, the drive arrangement remains static and acts as the hub of the wheel. In this way, the drive arrangement drives the drive wheel 160 at the bottom of the device and this drives the wheel 120 around the drive arrangement (i.e. the static hub).

It will be appreciated that, in other embodiments, the wheel may have a hub (i.e. not be a hubless wheel).

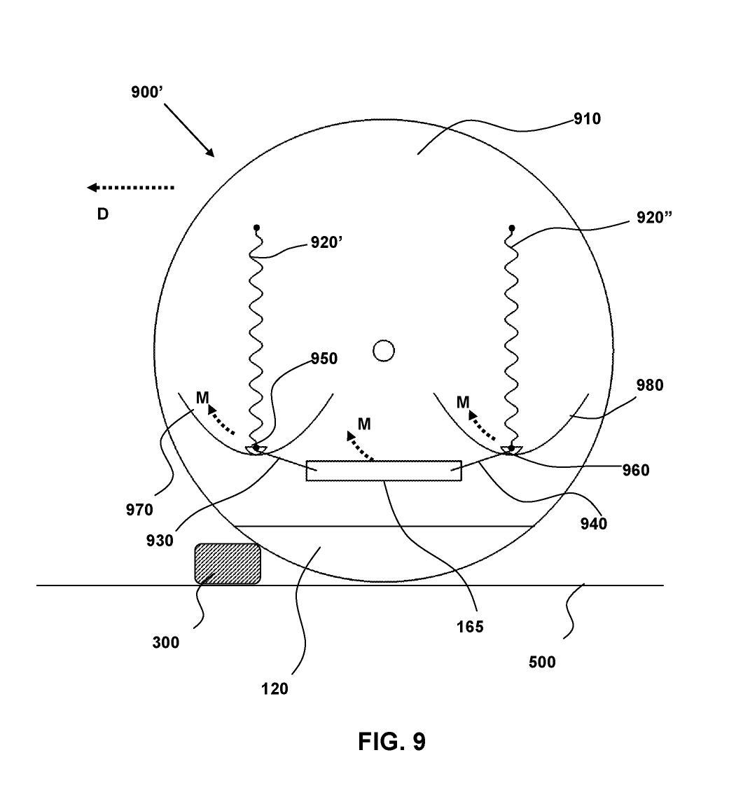

Turning now to FIG. 9, there is depicted a schematic diagram of another embodiment of a self-balancing powered unicycle 900. Like conventional self-balancing powered unicycles, the embodiment of FIG. 9 comprises: a drive arrangement (not visible) adapted to drive rotation of the single wheel 120; a balance control system (not visible) adapted to maintain fore-aft balance of the unicycle 900 by controlling rotation of the wheel 120 (via the drive arrangement for example); and first and second platforms 165 provided proximate to either side of the wheel 120 for supporting a user of the unicycle 900. However, unlike conventional self-balancing powered unicycles, the foot platforms 165 are coupled to the chassis or body 910 of the unicycle such that the foot platforms 165 can move relative to the chassis/body 910 in response to sudden or rapid horizontal acceleration or deceleration of the unicycle 900.

Here, the suspension arrangement comprises first 920′ and second 920″ resilient members, such as a spring, connected between the chassis/body 910 of the unicycle and first 950 and second 960 followers. The suspension arrangement also comprises first 930 and second 940 rigid connecting elements connected (at one end) to opposite ends of each foot platform 165. The other ends of the first 930 and second 940 connecting elements are connected to the first 950 and second 960 followers. The first 950 and second 960 followers are adapted to move (e.g. slide or roll) along first 970 and second 980 guide tracks, respectively, as the associated foot platform 165 moves with respect to the chassis or body 910 of the unicycle. Here, the first 970 and second 980 guide tracks are of substantially the same shape and size and they are laterally offset from each other so that they are positioned adjacent opposing ends of the associated foot platform 165. In particular, the first 970 and second 980 guide tracks are curved so as to be generally semi-circular or U-shaped.

It will be understood that this suspension arrangement can permit the foot platforms 165 to move relative to the chassis or body 910 of the unicycle, and such movement can be guided by the first 970 and second 980 guide tracks. Also, the curved or non-linear shape of the first 970 and second 980 guide tracks restricts movement of the foot platforms 165 to a curved or non-linear path. The matching shapes and dimensions of the first 970 and second 980 guide tracks also helps to maintain the foot platform in a substantially horizontal orientation when it moves relative to the chassis or body 910 of the unicycle.

The first 920′ and second 920″ resilient members are adapted to bias the first 950 and second 960 followers, respectively, in an upwards (i.e. vertical) direction. In this way, the first 920′ and second 920″ resilient members are adapted to apply a lifting force to the first 950 and second 960 followers which counteracts the weight of the foot platform 165 (and a user stood thereon). This may help to reduce the effective/running weight of the followers, and thus reduce or minimise the friction between the followers 950, 960 and the guide tracks 970, 980.

FIG. 9 depicts the unicycle 900 at the moment it hits an obstacle 300 when travelling a forward direction (as indicated by the arrow labelled “D”).

As the unicycle wheel 120 hits the obstacle 300 it undergoes a sudden deceleration. However, the forward momentum of the supported user (not shown) and the foot platforms 165 causes the foot platforms 165 to undergo a forward movement relative to the chassis or body 910 of the unicycle, as depicted by the arrows labeled “M”. This movement M is guided by the first 950 and second 960 followers moving along the first 970 and second 980 guide tracks, respectively. As a result, the movement follows has an upwardly-curved trajectory. Thus, linear momentum of the unicycle device in the forward direction “D” is transferred into a forward and upward movement “M” of the foot platforms 165 when the device hits the obstacle 300. Thus, at least part of the forward running momentum of the unicycle device is translated into swinging-like movement that has a vertical component. The vertical component of the movement M may act towards lifting the device and thus reduce an amount of torque/power required to overcome the bump or obstacle. In other words, the vertical component of the movement “M” of the foot platforms 165 may reduce the effective weight of the unicycle device, thus reducing or alleviating the power or torque required from the drive arrangement that would otherwise be required to overcome the obstacle.

Furthermore, because the upper (user-supporting) surface of the foot platforms 165 is maintained in a substantially horizontal configuration when it moves relative to the chassis or body 910 of the unicycle, the user-supporting-surface of the foot platform 165 does not tilt relative to the ground/supporting surface 500, for example. This may help to prevent the user from losing their balance, and thus improve the safety and/or usability of the device.

It will be appreciated that variations of the embodiments described above may employ other arrangements and/or mechanisms.

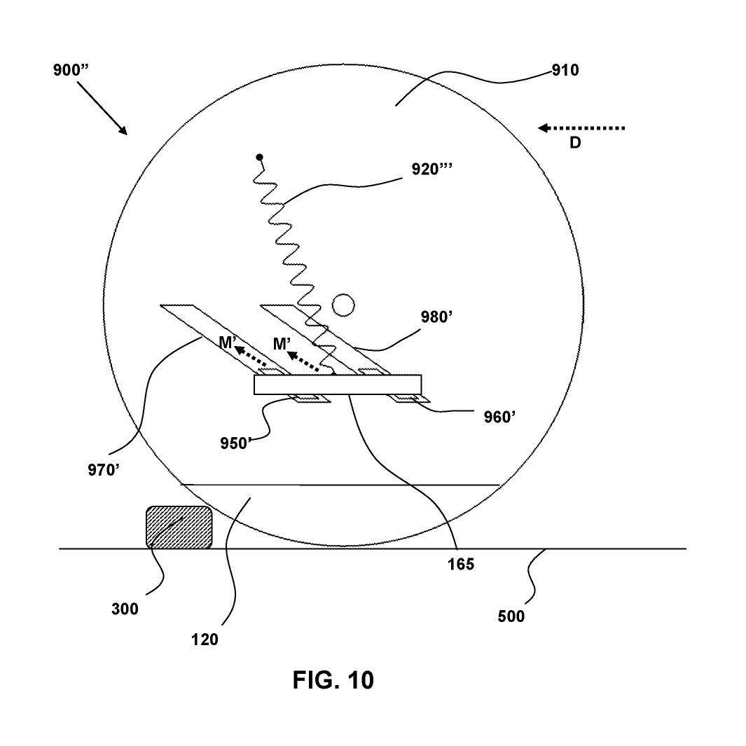

Turning now to FIG. 10, there is depicted a schematic diagram of another embodiment of a self-balancing powered unicycle 900″. Like conventional self-balancing powered unicycles, the embodiment of FIG. 10 comprises: a drive arrangement (not visible) adapted to drive rotation of the single wheel 120; a balance control system (not visible) adapted to maintain fore-aft balance of the unicycle 900″ by controlling rotation of the wheel 120 (via the drive arrangement for example); and first and second platforms 165 provided proximate to either side of the wheel 120 for supporting a user of the unicycle 900. However, unlike conventional self-balancing powered unicycles, there is provided a coupling arrangement which couples the foot platforms 165 to the chassis or body 910 of the unicycle such that the foot platforms 165 can move relative to the chassis/body 910 in response to sudden or rapid horizontal acceleration or deceleration of the unicycle 900″.

Here, the coupling arrangement comprises a resilient member 920″, such as a tension spring, connected between each foot platform 165 and the chassis/body 910 of the unicycle 900″. The suspension arrangement also comprises first 950′ and second 960′ followers provided at opposite ends of each foot platform 165. The first 950′ and second 960′ followers are adapted to move (e.g. slide or roll) along first 970′ and second 980′ guide tracks, respectively, as the associated foot platform 165 moves with respect to the chassis or body 910 of the unicycle. Here, the first 970′ and second 980′ guide tracks are of substantially the same shape and size and are laterally offset from each other so that they are positioned adjacent opposing ends of the associated foot platform 165. In particular, the first 970′ and second 980′ guide tracks are linear and extend in an upwardly-slanted parallel directions. The first 970′ and second 980′ guide tracks therefore define upwardly-extending parallel tracks along which the first 950′ and second 960′ followers are adapted to move (e.g. slide or roll).

It will be understood that this suspension arrangement can permit the foot platforms 165 to move relative to the chassis or body 910 of the unicycle, and such movement can be guided by the first 970′ and second 980′ guide tracks. Also, the linear shape of the first 970′ and second 980′ guide tracks restricts movement of the foot platforms 165 to a linear path that has a vertical component. The matching shapes and dimensions of the first 970′ and second 980′ guide tracks also help to maintain the foot platform 165 in a substantially horizontal orientation when it moves relative to the chassis or body 910 of the unicycle.

Under the control of a bias actuation arrangement (not shown), the resilient member 920″ is adapted to bias the foot platform 165 in an upwards direction such that it applies a lifting force to the foot platform 165 to counteract the weight of the foot platform 165 (and a user stood thereon). This helps to reduce the effective/running weight of the followers 950″, 960″, and thus reduce or minimise the running friction between the followers 950, 960 and the guide tracks 970, 980.

More specifically, in this embodiment, the bias actuation arrangement is adapted to dynamically apply or remove the lifting force to the foot platform under the control of an activation signal. The activation signal may, for example, be based on the application of a user's weight to the foot platform. In this way, the bias actuation arrangement may be adapted to bias the foot platform 165 in an upward direction against the weight of a user only when the user stands on the foot platform(s). Also, the activation signal may be based on the running characteristics of the unicycle as detected by one or more sensors, such as acceleration, deceleration, or impact sensors.

FIG. 10 depicts the unicycle 900″ at the moment it hits an obstacle 300 when travelling a forward direction (as indicated by the arrow labelled “D”).

As the unicycle wheel 120 hits the obstacle 300 it undergoes a sudden deceleration. However, the forward momentum of the supported user (not shown) and the foot platforms 165 causes the foot platforms 165 to undergo a forward movement relative to the chassis or body 910 of the unicycle, as depicted by the arrows labeled “M′”. This movement M′ is guided by the first 950′ and second 960′ followers moving along the first 970′ and second 980′ guide tracks, respectively. As a result, the movement follows has an upwardly-extending linear trajectory. Thus, linear momentum of the unicycle device in the forward direction “D” is transferred into a forward and upward movement M′ of the foot platforms 165 when the device hits the obstacle 300. Thus, at least part of the forward running momentum of the unicycle device is translated into movement M′ that has a vertical component. The vertical component of the movement M′ may act towards lifting the device and thus reduce an amount of torque/power required to overcome the bump or obstacle. In other words, the vertical component of the movement M′ of the foot platforms 165 may reduce the effective weight of the unicycle device, thus reducing or alleviating the power or torque required from the drive arrangement that would otherwise be required to overcome the obstacle.

As the device overcomes the bump or obstacle, the bias actuation arrangement is adapted to remove the lifting force to the foot platform under the control of a deactivation signal (from an accelerometer for example). In this way, the bias actuation arrangement removes the upward bias from the foot platform(s), thus resulting in downward movement of the foot platform(s) relative to the body or chassis of the device. Such relative movement further assists the device in overcoming the bump or obstacle.

Furthermore, because the upper (user-supporting) surface of the foot platforms 165 is maintained in a substantially horizontal configuration when it moves relative to the chassis or body 910 of the unicycle, the user-supporting-surface of the foot platform does not tilt relative to the ground/supporting surface 500, for example.

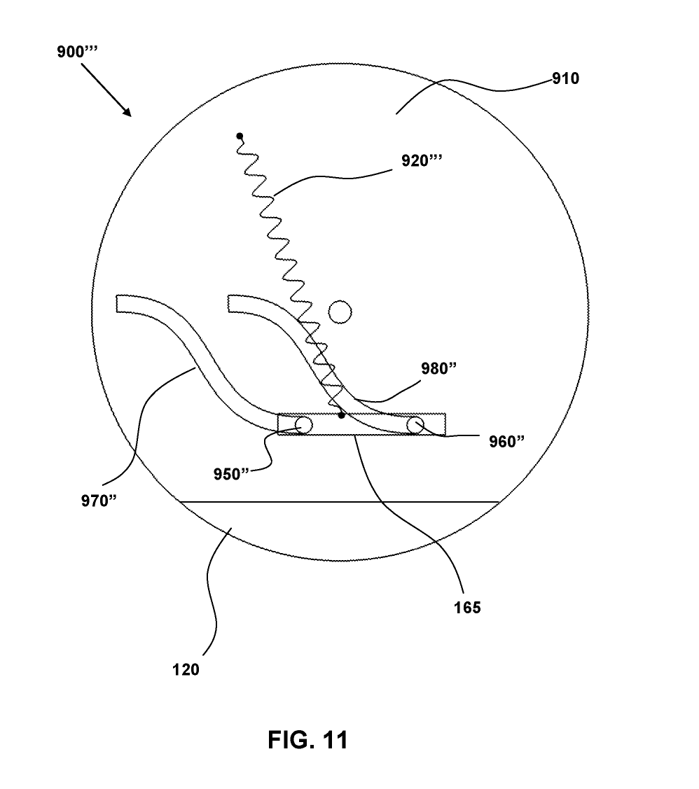

FIG. 11 depicts a modification to the embodiment of FIG. 10. More specifically, the embodiment of FIG. 11 is similar to that of FIG. 10, except that the first 970″ and second 980″ guide tracks are non-linear and, more particularly, the first 970″ and second 980″ guide tracks are curved in shape so that they have a somewhat wave-like shape. Here, the first 970″ and second 980″ guide tracks are of substantially the same shape and size and are laterally offset from each other so that they are positioned adjacent opposing ends of the associated foot platform 165. In particular, first 970″ and second 980″ guide tracks therefore define upwardly-extending parallel non-linear tracks along which the first 950″ and second 960″ followers are adapted to move (e.g. slide or roll).

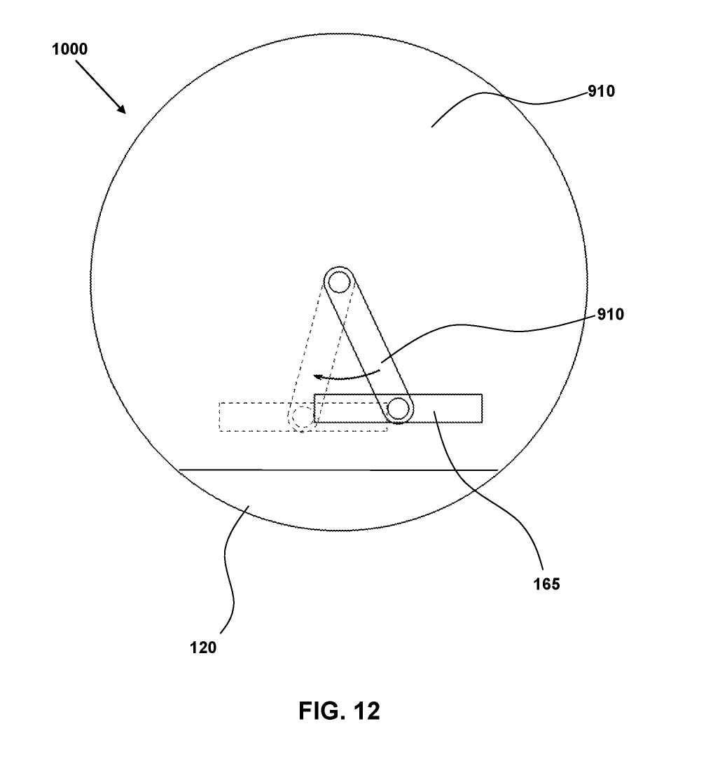

FIG. 12 depicts a modification to the embodiment of FIG. 10. More specifically, the self-balancing unicycle 1000 of FIG. 11 is similar to that of FIG. 10 except that the coupling arrangement comprises a link arm 1100 instead of a track and follower arrangement. The link arm 1100 comprises an elongate rigid bar having two ends. The link arm 1100 is pivotally coupled to the chassis/body of the unicycle 1000 at one end and is pivotally coupled to the foot/support platform 165 at the other end. In this way, the link arm 1100 can pivot with respect to the chassis/body of the unicycle 1000, and the link arm 1100 can also pivot with respect to its associated foot platform 165. In particular. Such movement is depicted by the arrow and dashed lines in FIG. 12. It will be understood that this linkage arrangement can help to maintain the foot platform 165 in a constant substantially horizontal orientation when it swings relative to the casing chassis/body of the unicycle 1000.

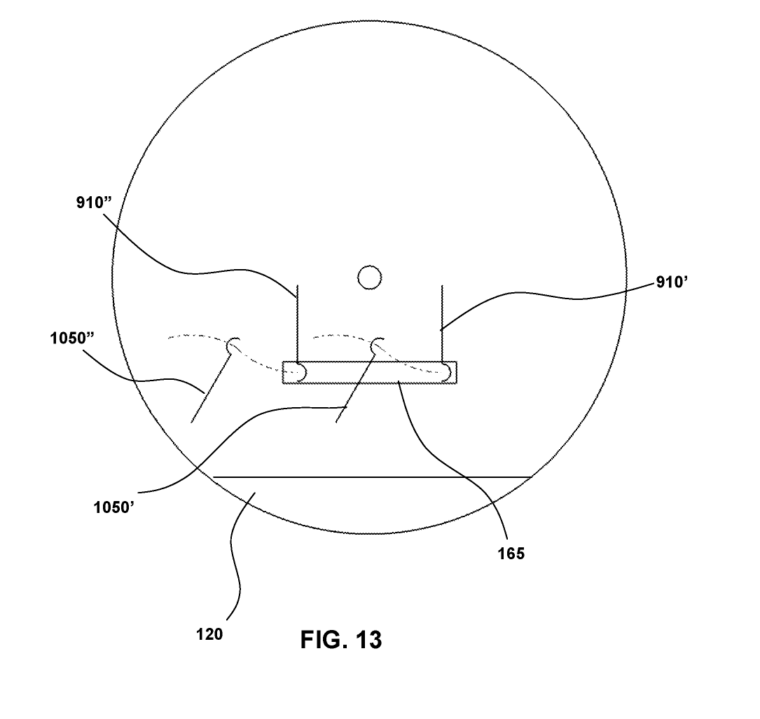

FIG. 13 depicts a modification to the embodiment of FIG. 12. More specifically, the self-balancing unicycle 1000 of FIG. 13 is similar to that of FIG. 12 except that the coupling arrangement comprises first 910′, 910″ and second 1050′, 1050″ pairs of parallel link arms (instead of a single link arm). Each link arm of the first pair has two ends, wherein an upper/top end is pivotally coupled to the chassis/body of the unicycle and the other, bottom end is formed as a hook that is adapted to releasably engage with the foot/support platform 165. Each link arm of the second pair has two ends, wherein a lower/bottom end is pivotally coupled to the chassis/body of the unicycle and the other, top/upper bottom end is formed as a hook that is adapted to releasably engage with the foot/support platform 165. In this way, the link arms 910′, 910″, 1050′, 1050″ can pivot with respect to the casing 110.

The first 910′, 910″ and second 1050′, 1050″ pairs of parallel link arms are laterally offset from each other so that they can releasably engage with foot platform 165 depending on the relative position/orientation of the link arms 910′, 910″, 1050′, 1050″ and the foot platform 165. It will be understood that this arrangement is adapted to pass the foot platform 165 between the pairs of the link arms. For example, such movement of the foot platform as guided by the link arms is depicted by the dashed lines in FIG. 13. It will be understood that this linkage arrangement can help to maintain the foot platform 165 in a constant substantially horizontal orientation when it moves relative to the casing chassis/body of the unicycle.

Embodiments may therefore be employed in a self-balancing powered transportation device to alleviate power or torque requirements on the drive arrangement. Such reduction of required torque, for example, may enable a smaller, lighter and/or cheaper motor to be employed, thus reducing the cost and/or weight of the device. It may also improve device safety by reducing (e.g. damping) the effect of hitting a sudden bump, obstacle, etc.

It is noted that the embodiments described above include two (e.g. left and right) foot platforms. It is to be understood that proposed embodiments need not be restricted to being employed to move two foot platforms, but may instead be employed to move only a single foot platform. Indeed, self-balancing powered unicycles having a single foot platform that extends through the unicycle so as to project from either side are already available. Also, while specific embodiments have been described with reference to a powered self-balancing unicycles having foot platforms, it is to be understood that embodiments need not be restricted to powered self-balancing unicycles, but may instead be employed in self-balancing transportation devices having more than one wheel and/or a supporting platform for supporting a user (such as a seat for example). By way of example, embodiments may include powered self-balancing two-wheeled transportation devices having a support platform situated between the two wheels (so that the user is intended to stand or sit between the two-wheels for example). In such embodiments, there may be provided a single support platform for supporting the user (between the wheels), and the support platform may be suspended from a chassis of the device by a coupling arrangement that is adapted to allow the support platform to swing relative to the chassis.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Accordingly, while specific embodiments have been described herein for purposes of illustration, various modifications will be apparent to a person skilled in the art and may be made without departing from the scope of the invention.

1. A self-balancing transportation device comprising:
a chassis;
a drive arrangement adapted to move the transportation device;
a balance control system adapted to maintain fore-aft balance of the transportation device;
at least one support platform for supporting a load for transportation; and
a coupling arrangement configured to couple the at least one support platform to the chassis, the coupling arrangement being adapted to allow the at least one support platform to move relative to the chassis in response to horizontal acceleration or deceleration of the transportation device.

2. The transportation device of claim 1, wherein the coupling arrangement is adapted to maintain the at least one support platform in a constant orientation when it moves relative to the chassis.

3. The transportation device of claim 2, wherein the coupling arrangement comprises a mechanical linkage having at least one link arm, wherein the at least one link arm has two ends and is pivotally coupled to the chassis at one end and is pivotally coupled to the at least one support platform at the other end.

4. The transportation device of claim 3, wherein the coupling arrangement comprises two link arms that are of substantially equal length such that the two link arms together with the chassis and the at least one support platform form a parallelogram four bar linkage.

5. The transportation device of claim 1, wherein the coupling arrangement comprises a track and follower for guiding the allowed movement of the at least one support platform along a predetermined path.

6. The transportation device of claim 5, wherein the predetermined path extends in an upward direction.

7. The transportation device of claim 5, wherein the predetermined path is non-linear.

8. The transportation device of claim 1, further comprising a biasing arrangement adapted to apply a lifting force to the at least one support platform.

9. The transportation device of claim 8, further comprising a bias actuation arrangement that is adapt to apply or remove the lifting force to the at least one support platform under control of an activation signal.

10. The transportation device of claim 9, wherein the activation signal is based on one or more operating characteristics of the transportation device.

11. The transportation device of claim 1, wherein the load for transportation comprises a person.

12. The transportation device of claim 1, wherein the load for transportation comprises a package or item for delivery and wherein the drive arrangement is adapted for automated control.

13. The transportation device of claim 1, wherein the coupling arrangement is adapted to restrict or prevent the at least one support platform from moving relative to the chassis if the horizontal acceleration or deceleration of the transportation device is less than a predetermined threshold value.

14. The transportation device of claim 1, wherein the transportation device is a self-balancing unicycle device having a single primary wheel adapted to be driven by said drive arrangement.

15. The transportation device of claim 14, wherein the single primary wheel is hubless and wherein the drive arrangement comprises a drive wheel adapted to be rotated by a motor and to contact an inner rim of the single primary wheel.

16. The transportation device of claim 1, wherein the transportation device comprises a pair of wheels.

17. The transportation device of claim 14, further comprising:
an actuator arrangement coupled to the at least one support platform and adapted to move the at least one support platform between a stowed configuration and an active configuration.

18. The transportation device of claim 17, wherein the actuator arrangement comprises: a telescoping actuator adapted to move between an extended and retracted configuration so as to move the at least one support platform between the stowed configuration and the active configuration.
